(19) United States
(12) Patent Application Publication
(10) Pub. No.: US 2011/0181469 A1
(43) Pub. Date: Jul. 28, 2011

(54) METHOD AND APPARATUS FOR DETERMINING THE CHANGING POSITION OF A MOBILE TRANSMITTER

(75) Inventors: Andreas Eidloth, Erlangen (DE); Norbert Franke, Erlangen (DE)

(73) Assignee: FRAUNHOFER-GESELLSCHAFT ZUR FÖRDERUNG DER ANGEWAND, Muenchen (DE)

(21) Appl. No.: 13/002,927

(22) PCT Filed: Jul. 8, 2009
(86) PCT No.: PCT/EP2009/005096

§ 371 Date: Apr. 11, 2011

(30) Foreign Application Priority Data
Jul. 8, 2008 (DE) 10 2008 032 983.5

(51) Int. Cl. G01S 1/24

(52) U.S. Cl. 342/387

(57) ABSTRACT

A method and a device for determining the changing position of a mobile transmitter in a three-dimensional space is proposed in which transmitted signals are issued at a pre-determined frequency from a mobile transmitter, wherein a plurality of receivers receive said transmitted signals. An evaluation device evaluates the received signals for generating correlation curves between the transmitted and the received signals. From the curves of magnitude versus time, TOA values are determined, and from curves in the complex plane, phase values are determined using the time information from the TOA values. The position of the mobile transmitter is calculated as a function of TOA values and of phase or phase difference values.

The invention relates to a method for determining the changing position of a mobile transmitter in a three-dimensional space in accordance with the preamble of the main claim and to an apparatus for carrying out the method in accordance with the preamble of the independent claim.

A method for the continuous real-time tracking of the position of at least one mobile object as well as associated transmitters and receivers are known from EP 1 556 713 B1 in which a transmitter attached to the object and a plurality of receivers of a stationary receiver and signal processing network are provided, wherein the signals emitted by the transmitter are electromagnetic waves transmitted in a frequency band range in the time multiplex process and the transmission pattern of the transmitter is already known to the receivers. Time of arrival (TOA) values between the transmitter and the respective receivers are determined from the received signals while taking the transmitted signals into account, with this being carried out by evaluation of the amplitude of correlation curves over time. Eleven time difference of arrival values, so-called TDOA values, were formed from, for example, twelve TOA values of twelve receivers by reference to one of the receivers and the respective position of the transmitter is calculated from them by hyperbolic triangulation which is implemented in a Kalman filter, with speeds and accelerations then also being known. This process or this known apparatus was used, for example, for real-time tracking of a ball and/or of players on a playing field, e.g. a soccer field.

As was stated, the TOA value was acquired from the absolute value graph of the correlation between the transmitted signal and the received signal over time by determining the maximum of the curve. Such a correlation curve is, however, considerably deformed by multipath propagation due to reflections of the transmitted signal so that the reliability of the TOA values falls considerably under certain circumstances so that a precise association with the LOS component (LOS—line of sight) of the signal propagation may become less distinct.

It is thus the underlying object of the invention to provide a method for determining the changing position of a mobile transmitter in a three-dimensional space in which the accuracy of the calculation of the positions is improved and in particular effects due to multipath signal propagation are reduced.

This object is satisfied in accordance with the invention by the characterizing features of the main claim in connection with the features of the preamble.

Advantageous further developments and improvements are possible by the measures set forth in the dependent claims.

Since correlations curves are prepared as graphs in the complex plane in the evaluation of the received signals in addition to the correlation curve as an absolute value over time and since phase values are determined from these graphs in the complex plane using information from the absolute value graphs and subsequently the position of the mobile transmitter is determined while taking account of the TOA values and of the phase values, in particular movement trajectories, i.e. movement profiles of the transmitters, can be largely freed from effects of the multipath signal propagation so that the position calculation is improved as a whole. The absolute position is rather given by the TOA values in the position result, whereas the phase information ensures that relative movements are shown very distinctly.

Phase difference values between two receivers are preferably respectively calculated and used for the evaluation when the transmitter or transmitters is/are not synchronized with the receivers. In the event that the transmitter or transmitters are synchronized with the receivers or with the receiver network, the phase values can be used directly.

In an advantageous embodiment, the TOA values are obtained by determining the inflection point of the absolute value of the correlation curve, the selection of this point improves the accuracy since the inflection point lies on the LOS curve which represents the distance to be measured and is therefore better suitable for fixing the TOA value than the maximum.

It is particularly advantageous that a receiver serves as a reference receiver and phase difference values are calculated with respect to the reference receiver.

It is advantageous that the transmitted signals are modulated onto a carrier frequency, with the system in accordance with the invention not being restricted to the frequencies, bandwidths and modulation types set forth in the embodiment. The system can, for example, equally be configured for the 5 GHz ISM band and other frequency bands in addition to the 2.245 GHz band. All modulation types for generating the code sequences can be used, inter alia QPSK, BPSK, 8PSK, BOC (binary offset carrier) or the like.

The evaluation device preferably includes a Kalman filter which delivers the three-dimensional position and the three-dimensional speed of the respective movable transmitter. If desired, the three-dimensional acceleration is also determined.

In an advantageous embodiment, the evaluation device includes an evaluation unit and one or more central processors in each receiver; however, the evaluation can also be carried out in another division, e.g. only in the receivers or only in central units.

The method in accordance with the invention describes a possibility to determine a phase measurement, more precisely a carrier phase measurement, from the complex correlation and to carry out a much more accurate position determination using this additional information together with the TOA values known per se. A very accurate trajectory of the object to be located can be found with the aid of the phase measurement; however, this trajectory is undetermined in its absolute position, whereas a relatively noisy position, which is, however unambiguous in its absolute value, is determined from the TOA measurement. If both measured values are combined with one another, e.g. in a Kalman filter, with the TOA values being input with greater noise uncertainty for a long-term averaging and the measured phase values being input with less noise uncertainty, a position result is obtained which includes the advantages of the two measured values, i.e. accurate position profiles are obtained with the correct absolute position.

An embodiment of the invention is shown in the drawing and will be explained in more detail in the following description. There are shown:

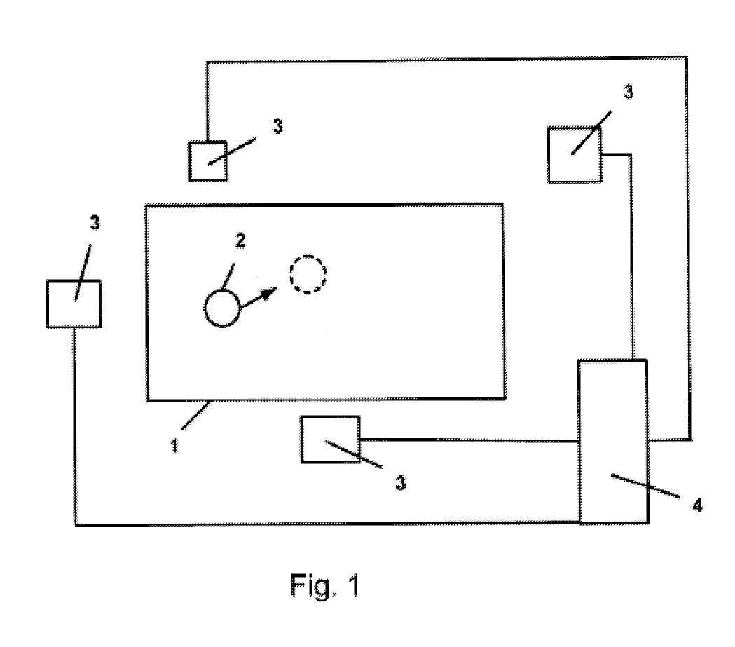

FIG. 1 a schematic view of an embodiment of the apparatus in accordance with the invention;

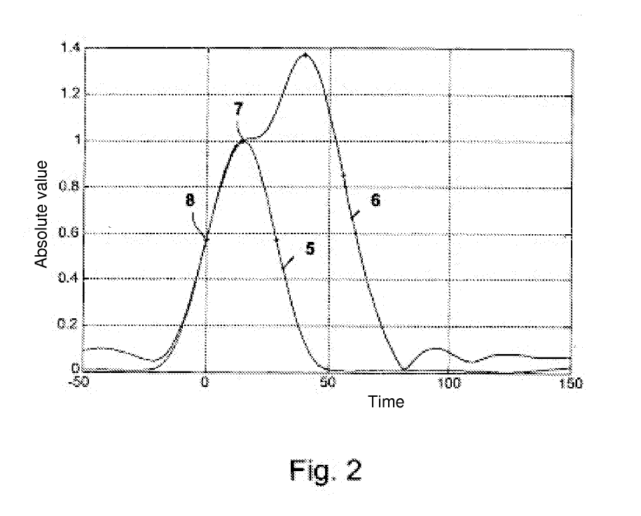

FIG. 2 a representation of correlation curves as an absolute value over time;

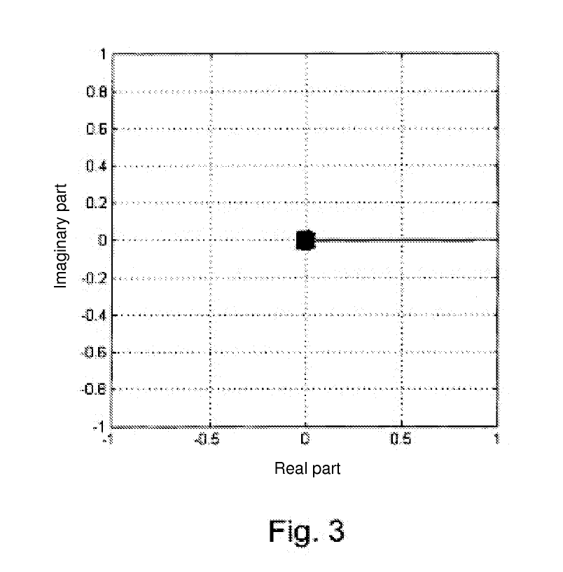

FIG. 3 an ideal correlation curve in the complex plane;

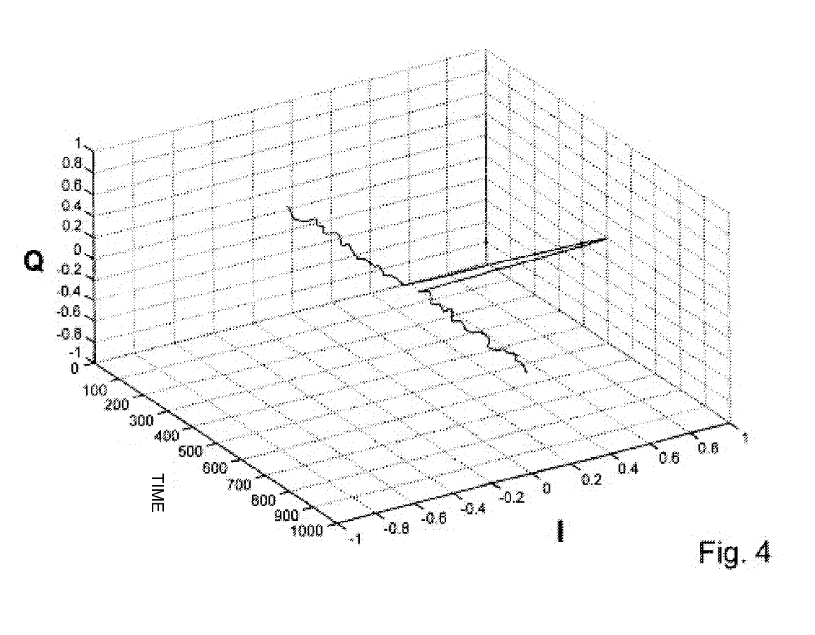

FIG. 4 a 3D representation of an ideal complex correlation;

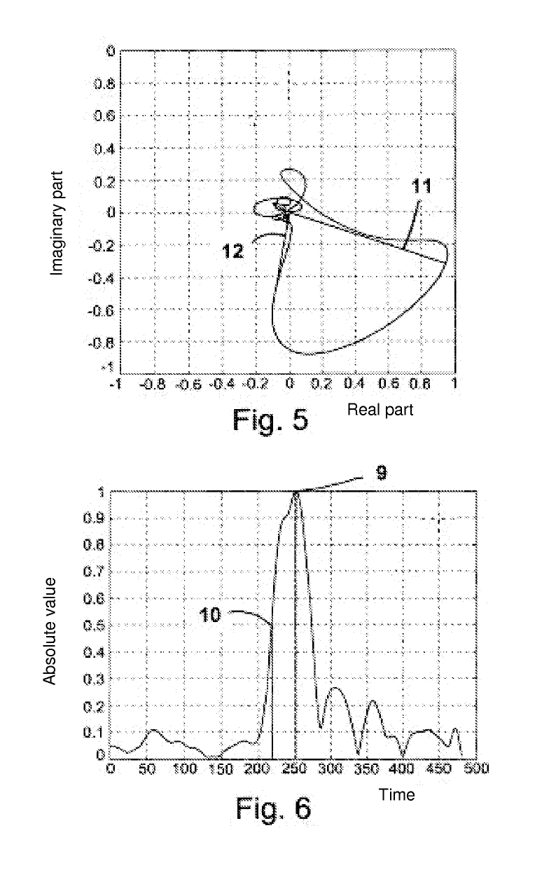

FIG. 5 a representation of the graph of a correlation in the complex plane deformed by multipath propagation;

FIG. 6 a representation of the absolute value graph of the correlation over time in accordance with FIG. 5; and

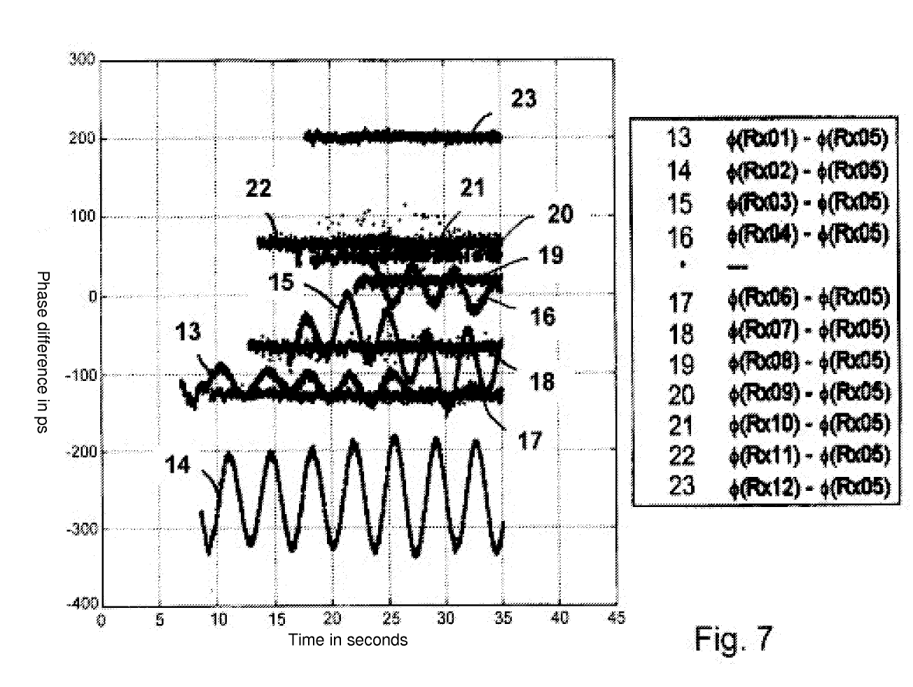

FIG. 7 a representation of measured phase difference values of a stationary transmitter of a plurality of receivers.

An apparatus in accordance with the invention is shown in FIG. 1 which serves continuously to track a moving object. The moving object can be one or more balls and/or one or more transmitters on players who move on a playing field 1. In this respect, a transmitter 2 which moves with the ball or player is attached to each object. In the embodiment, four receivers 3 are attached in a fixed manner around the playing field and are time-synchronized with one another, in the embodiment are connected to a common clock source and are connected to one or more central processors 4 via fixed lines, radio or other transmission means. More receivers can naturally be provided to achieve a particularly accurate tracking of the position of an object.

The transmitter 2 or transmitters 2—in the following description, however, only one transmitter is always spoken of—in the present embodiment transmits/transmit a signal modulated onto a selected carrier frequency of 2445 MHz having a modulation bandwidth of approximately 77 MHz, said signal being modulated, for example, in accordance with the QPSK method (quadrature phase shift keying) and is radiated as a sequence of signal bursts from the transmitter 2. The receivers 3 receive the transmitted signal bursts and process the received signals by “down-mixing” from 2445 MHz into the base band and continuous sampling. In this respect, the carrier frequency is removed; the phase information is maintained. The digitized value are transmitted to the processor 4 for further processing. The processor 4 forms, optionally with a part of the receiver 3, an evaluation device.

Correlation curves are prepared in the receivers 3 or in the processor 4 such as are shown in FIGS. 2 to 4 for an ideal state and in FIGS. 2, 5 and 6 for a real state with multipath propagation.

A TOA value which is generated in each case by a receiver 3 is determined from FIG. 2 which shows the absolute value graph of an ideal correlation 5 and of a correlation 6 deformed by multipath propagation over time. The TOA value can be determined using the maximum amplitude 7 or the inflection point 8. As can, however, be recognized with reference to FIG. 2, curve 6, the ideal correlation graph 5 is deformed, considerably in part, by multipath propagation, whereby a precise association of a “correct maximum” is only poorly possible.

It would in principle be desirable for the ideal TOA value acquisition from its correlation curve if the “correlation peak” had an infinitesimally small time extent. However, this is not the case in the realization, but the time extent rather depends on the modulation bandwidth used and indeed inversely proportionally to the symbol rate. In the present embodiment, the bandwidth of 77 MHz results with an ideal correlation in a time expansion of approximately 50 ns at 30% of the amplitude of the correlation peak. Figuratively spoken, the curve is thereby less sharp and the TOA value can be read less distinctly. Long reflection detours result in a plurality of correlation peaks which are clearly separable in time and can be clearly distinguished. However, short reflection detours result in a plurality of correlation peaks or correlation maxima which, however, fuse with one another in the total curve shape (see FIG. 2). The reading of the TOA value thereby becomes more difficult and error-prone.

As was already described in connection with the prior art, TDOA (time difference of arrival) values were formed from the TOA values for the determination of the movement trajectories; however, this can result in results containing effects due to the multipath propagation.

A complex correlation curve which is shown for the ideal correlation in FIGS. 3 and 4, is therefore determined in accordance with the invention from the signal bursts having complex modulation. As can be recognized in these Figures, there is also a correlation peak here and it becomes clear that this correlation peak has an angular orientation in the complex plane. Precisely this angle produces an additional piece of information which is additionally processed as a measured value in accordance with the invention. The positive property which is utilized is the fact that the result for the angle is influenced a lot less by multipath propagation. Ultimately the selected carrier frequency and not, as explained above with respect to the TOA value, the modulation bandwidth corresponds to the signal bandwidth which determines the precision of the angle result. The ability to be influenced of the phase value by multipath propagation is thus lower in the estimate in the current embodiment by approximately the factor 32, namely 2445 MHz/77 MHz=31.75. The spatial monomode range of a phase result corresponds to a wavelength, i.e. in the present case 12.3 cm corresponding to the center frequency of 2445 MHz,

The graphs in the complex plane (FIG. 5) and of the absolute value in dependence on time (FIG. 6) of a really measured correlation curve are shown in FIGS. 5 and 6. It can be seen in FIG. 6 that the maximum 9 of the correlation curve is made up of two overlapping, ideal correlations, with this indicating a propagation behavior with two paths, for example a propagation corresponding to the line of sight (LOS) and with base reflection.

The inflection point 10 is marked beside the maximum 9 in FIG. 6. The maximum 9 would deliver an incorrect TOA and thus a measured distance result since it has been clearly displaced in time by the influence of the reflection path. The inflection point is better suitable for fixing the TOA value since it lies on the LOS curve which represents the distance to be measured.

The graph of the correlation deformed by multipath propagation in the complex plane is now shown in FIG. 5, with the phase angle 11 being shown from the maximum and the phase angle 12 from the inflection point of the absolute value graph in accordance with FIG. 6. These values are obtained in that the time information from the absolute value graph is transferred to the graph of the deformed correlation in FIG. 5 by “moving along” on the curve. The phase angle is in each case defined between the lines 11, 12 and the abscissa. The absolute value curve over time and the complex correlation are generally equivalent representations which can be drawn starting from the sampling values or from the obtained result values of the correlation which are exactly the same. The time reference between the absolute value representation and the complex representation is thus also unambiguous and transferrable.

The maximum and the inflection point were selected as characteristic points on the correlation curve in FIG. 5. In principle, any desired characteristic point can be selected in the determination of the phase in the specific embodiment since measured value differences are formed. The only condition is that the two measured phase values, from which a difference is formed, correspond to a criterion defined in the same manner.

The phase values thus found for each receiver from the curves of FIG. 5 are further processed in the processor 4 in that respective phase differences are formed between two receiver locations. The receivers 3 are, as stated, connected to one another in phase-locked manner thanks to networking to a common clock source, for example a clock and trigger generator. The absolute phase value at a receiver 3 has no validity since the transmitter 2 is not synchronized with the receiver network. The phase differences however, do have the desired validity. If e.g. a transmitter 2 does not move between the transmitted bursts, the phase difference obtained between two receivers 3 is the same in the first burst as in the second burst. The information can then e.g. be used in the position result so that the position cannot have changed.

If, however, a movement of the transmitter 2 is present, the phase differences change in accordance with the direction of movement of the transmitter 2 and in accordance with the geometrical arrangement of the receiver antennas. If phases or phase difference values are processed, the relative movement between two bursts can be represented with an influence by multipath propagation reduced in the embodiment by up to a factor of 32 in comparison with a pure, TOA value processing. It is advantageous for the three-dimensional imaging in space if, as in the embodiment just described, a plurality of receivers is provided, with their distribution in space, however also the attachment of the transmitters to the moving object, influencing the three-dimensional accuracy.

Measured phase difference values of a stationary transmitter 2 of a plurality of receivers, of twelve receivers 3 in FIG. 7, are shown by way of example in FIG. 7. The individual curves show the measured phase differences between two respective receivers. For this purpose, the differences were always formed with respect to the receiver with the number 5 (Rx05) which is mounted in an absolutely rigid and fixed manner. Four curves 13, 14, 15, 16, which show oscillations, can be recognized in FIG. 7. They belong to the receivers Rx01 to Rx04, which are receivers which are fastened so that they can still be moved slightly. Furthermore, seven curves 17 to 23 without oscillations can be recognized; the receivers belonging thereto are likewise attached in an absolutely rigid manner. The measured phase values were not drawn in degrees or radiants, but in picoseconds since such a conversion allows an improvement of the comparison with TOA values. This can be done via a simple conversion with the assistance of the carrier frequency and the speed of light. In this respect, 409 psec correspond to a wavelength of 12.3 cm or 360° in the phase. A position resolution capability of the system for relative movements in the range of a few millimeters results by the low noise on the phase difference curves.

On the movement of the transmitter 2, in the embodiment on the playing field 1, said transmitter may in principle not move further than ± half a wavelength between two bursts in order not to damage the unambiguity of the phase measurement. This is the case e.g. with a transmitter 2 which is fastened in a soccer ball at the known speeds which occur of up to 150 k.p.h. and a burst rate of 2000 a second, i.e. at 150 k.p.h. and 2000 bursts, the ball actually moves by only about 2 cm between 2 bursts. In the embodiment, the burst rate at a transmitter 2 which is fastened to a player is typically 200 a second. The monomode range can be infringed here if the transmitter 2 is fastened to the end of extremities which can oscillate very fast. It is, however, possible to use prediction processes for the movement speed, with the unambiguity window of the phase measurement being correspondingly displaced in accordance with the movement speed just being applied.

In the processor, all the TOA or TDOA and phase values or phase difference values are used to determine the positions. Usually, Kalman filters are used for the evaluation, with other processes and processing apparatus, however, also being able to be used such as algebraic algorithms, e.g. the Bancroft algorithm or such as neuronal networks or particle filters. Three coordinates for the position (X, Y, Z), three vector components of the speed V_{X}, V_{Y}, V_{Z} and three vector components for the acceleration A_{X}, A_{Y}, A_{Z} are delivered from the result of the Kalman filter. In this respect, TOA values, with their absolute and unambiguous character, are brought into correlation with the position, whereas the continued development of the phases is put into relation with the speed. At the same time, the positions, speeds and accelerations react with one another via the derivation relationships and statistic mechanisms of the Kalman filter.

1. A method for determining the changing position of a mobile transmitter in a three-dimensional space comprising the following steps:
transmitting signals at a preset frequency by the mobile transmitter;
receiving the transmitted signals by a plurality of receivers; and
evaluating the received signals and preparing correlation curves of correlation between transmitted signals and received signals, wherein the curves include absolute value graphs over time;
determining time of arrival (TOA) values from the absolute value graphs at a characteristic point,
wherein the evaluation step includes preparing of correlation curves as graphs in a complex plane and, furthermore, the following steps are provided:
determining phase values from the graphs in the complex plane using the time information of the TOA values and the angular orientation of the characteristic point in the graphs of the correlation curves in the complex plane; and
calculating the position of the mobile transmitter while taking account of the TOA values and the phase values.

2. The method in accordance with claim 1, wherein the transmitted signal is modulated onto a carrier frequency and is radiated as a sequence of transmitted bursts.

3. The method in accordance with claim 1, wherein the respective TOA value is acquired from one of a correlation maximum and an inflection point of the respective correlation curve of the absolute value over time.

4. The method in accordance with claim 1, wherein a characteristic point, is selected on the correlation curve for determining the phase value, with this point being selected the same for all receivers.

5. The method in accordance with claim 1, wherein phase difference values are calculated between two respective receivers and are used for determining position.

6. The method in accordance with claim 1, wherein the receivers are synchronized in time.

7. The method in accordance with claim 1, wherein the transmitter or transmitters are additionally synchronized in time with the receiver network.

8. The method in accordance with claim 1, wherein at least one of three-dimensional position, three-dimensional speed and/or three-dimensional acceleration is/are determined using a Kalman filter and/or a calculation manner in accordance with Bancroft or a neuronal network or particle filter.

9. An apparatus for determining the changing position of a mobile transmitter in a three-dimensional space, the apparatus comprising:
a plurality of receivers for receiving the transmitted signals which are output by the mobile transmitter and which have a preset frequency
an evaluation device for preparing correlation curves of correlation between transmitted signals and received signals, wherein the correlation curves include absolute value graphs over time for determining time of arrival (TOA) values from the absolute value graphs at a characteristic point; and
wherein the evaluation device is configured to prepare correlation curves as graphs in the complex plane, to determine phase values from the graphs in the complex plane using the time information of the TOA values for each receiver and the angular orientation of the characteristic point in the graphs of the correlation curves in the complex plane and to calculate the position of the mobile transmitter while taking account of the TOA values and of the phase values.

10. The apparatus in accordance with claim 9, wherein the transmitted signal is a code sequence which is modulated onto a carrier frequency and which the mobile transmitter transmits as a sequence of transmitted bursts.

11. The apparatus in accordance with claim 9, wherein the receivers are synchronized in time among one another.

12. The apparatus in accordance with claim 9, wherein the receivers are connected in a phase-locked manner via a common clock source.

13. The apparatus/in accordance with claim 9, wherein the transmitter or transmitters are additionally synchronized in time with the receiver network.

14. The apparatus in accordance with claim 9, wherein one receiver from the plurality of receivers is a reference receiver with which the respective phase difference values can be determined.

15. The apparatus in accordance with claim 9, wherein the evaluation device includes evaluation units respectively provided in each receiver and at least one processor receiving information from all evaluation units.

16. The apparatus in accordance with claim 9, wherein the evaluation device includes a device for calculating at least one of the three-dimensional absolute position and the three-dimensional speed and and/or the three-dimensional acceleration from the TOA values and from the phase values or from the phase difference values.

17. The apparatus in accordance with claim 16, wherein the evaluation device has a Kalman filter and/or a calculation manner according to Bancroft or a neuronal network or particle filter.

18. The apparatus in accordance with claim 9, wherein the transmitted signal has a carrier frequency of 2445 MHz and a modulation bandwidth of approximately 77 MHz or a carrier frequency of 5.8 GHz and a modulation bandwidth of approximately 150 MHz.

19. The method in accordance with claim 4, wherein the characteristic point includes an inflection point on the correlation curve.

20. The method of claim 7, wherein the transmitters are connected in a phase-locked manner, and wherein the receivers are connected in a phase-locked manner.
